(19) United States
(12) Patent Application Publication
(10) Pub. No.: US 2020/0115109 A1
(43) Pub. Date: Apr. 16, 2020

(54) MAILING PACK WITH CLEAR WINDOWS AND FILE FOLDER EMBODIMENTS

(71) Applicant: Gary M. Bell, Crystal, MN (US)

(72) Inventor: Gary M. Bell, Crystal, MN (US)

(21) Appl. No.: 16/536,587

(22) Filed: Aug. 9, 2019

Related U.S. Application Data
(60) Provisional application No. 62/744,404, filed on Oct. 11, 2018.

(51) Int. Cl. B65D 27/04; B65D 81/03; B65D 27/14; B65D 27/34; G01V 8/10

(52) U.S. Cl. CPC B65D 27/04; B65D 81/03; G01V 8/10; B65D 27/34; B65D 27/14

(57) ABSTRACT

In some embodiments, an enveloping mailing container with four edges includes a top edge, an opaque front side, an opaque back side sealed together to form three edges, and a sealable opening at the fourth edge. The enveloping mailing container may define an interior space between the front and back sides and a mailing address section on the front side and spaced away from the edges. The enveloping mailing container further may include least one transparent section defined on the front and/or back side, an extended lip seal, and a perforation tear line that extends downwardly away from the top edge for at least a portion of the perforation tear line. The enveloping mailing container may be formed of 100% recycled material adapted to receive laser energy configured to provide a pre-designed pattern on the enveloping mailing container.

### CROSS-REFERENCE TO RELATED APPLICATIONS

This application claims priority to U.S. provisional application Ser. No. 62/744,404, filed Oct. 11, 2018 and titled MAILING PACK WITH CLEAR WINDOWS AND FILE FOLDER EMBODIMENTS, the entire contents of which are incorporated herein by reference.

### BACKGROUND OF THE INVENTION

### Field of the Invention

The invention generally relates to enveloping mailing containers that provide the ability to see what is inside the containers without compromising the confidentiality of documents within.

### Description of the Related Art

Known envelopes generally do not allow a visualization of potentially dangerous materials held therein. There are paper envelopes that provide a transparent window for the recipient's address, generally located in the middle portion of the front side of the envelope, and the sender's address, generally located in the upper left corner of the front side of the envelope. However, larger envelopes and mailing devices do not provide a viewing window for visualization of potentially dangerous substances or materials, e.g., powder, contained therein while still maintaining the confidentiality of the documents or other items held within the envelope or mailing device.

Moreover, it would be highly advantageous to make these devices from 100% recycled materials.

The present invention overcomes these deficiencies and provides, inter alia, the above-referenced improvements.

### BRIEF SUMMARY OF THE INVENTION

An enveloping mailing container comprising a substantially opaque front and back side with at least one transparent section defined on the front and/or the back side of the enveloping mailing container. The at least one transparent section allows visualization of contents therein such as dangerous powder or other materials and/or confirmation that no dangerous powder or other materials are present in the container without compromising the confidentiality of the materials legitimately mailed in the enveloping mailing container.

The subject mailing container may be manufactured from recycled materials (e.g., 100% recycled materials), may be reusable, and may also be used as a file folder for documents, thereby reducing entry of materials into the waste stream. In addition, the mailing container may comprise a bubble pack liner and/or be amenable to creating laser designs or patterns on the mailing container for branding or other purposes.

### BRIEF DESCRIPTION OF THE DRAWINGS

FIG. 1 is a front perspective view of an embodiment of an enveloping mailing container, one or more features of which may be included in the present invention.

FIG. 2 is a front view of the enveloping mailing container of FIG. 1.

FIG. 3 is a rear view of an embodiment of the enveloping mailing container of FIG. 1.

FIG. 4 is a front view of an embodiment of the present invention adapted to serve as a file folder for documents.

FIG. 5 is a cross-sectional view of the front and/or back sides of the embodiment of FIG. 4, where the cross-section is taken along a line substantially parallel to the edges 1 and 3.

FIG. 6 is a front view of an embodiment of the present invention having a laser-produced design provided thereon.

### DETAILED DESCRIPTION

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

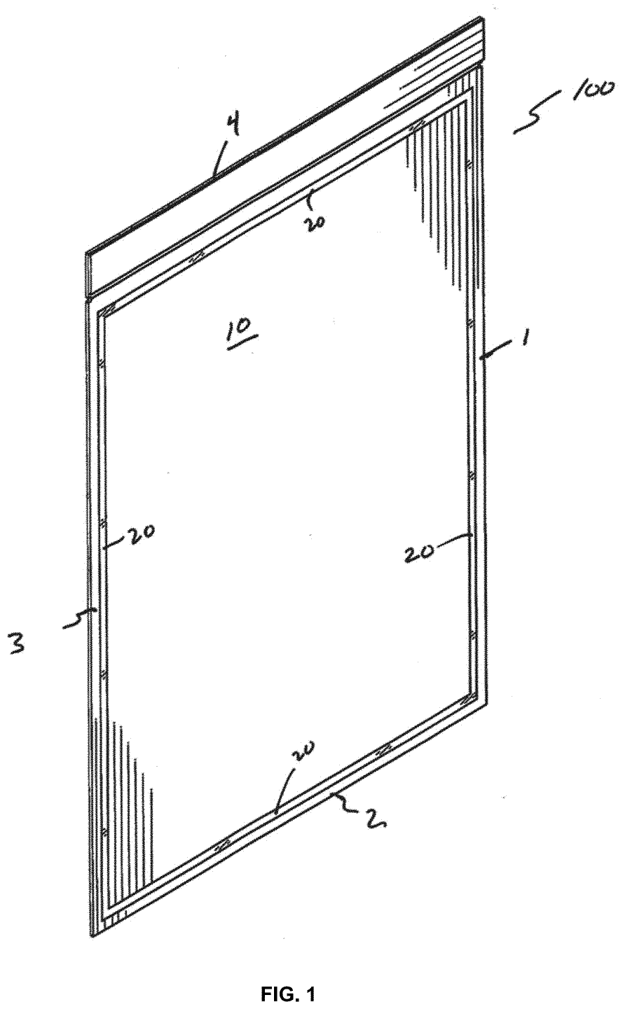

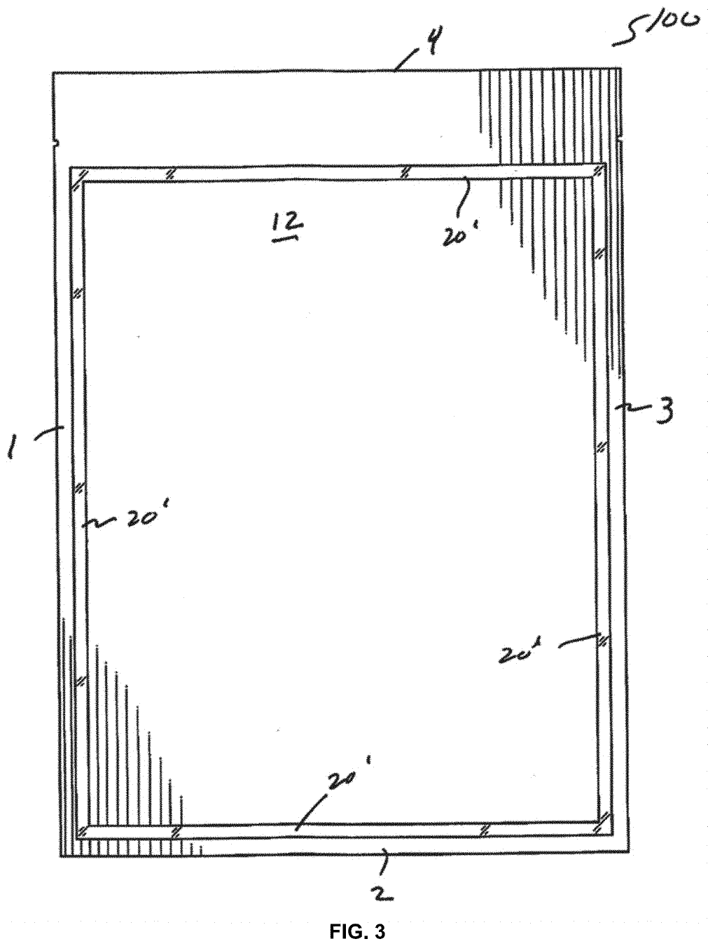

FIGS. 1-3 illustrate an enveloping mailing container 100 having a transparent security window 20. Enveloping mailing container 100 illustrates general features that may be included in any embodiment of the present invention, alone or in any combination. FIGS. 1-3 and corresponding descriptions thereof also are included in U.S. patent application Ser. No. 15/928304, filed Mar. 22, 2018 and entitled Enveloping Mailing Container with Transparent Security Window, which is incorporated herein by reference in its entirety.

With reference to FIGS. 1-3, enveloping mailing container 100 comprises a front side 10 and a back side 12, the front and back sides 10, 12 sealed together by known means along three of four edges, such as edges 1, 2, and 3 as shown in FIG. 1. In the illustrated embodiment, a fourth edge 4 of the enveloping mailing container comprises the opening into which the mailing materials are slid into an interior space 14 defined within the enveloping mailing container 100 as is commonly known with sealable envelopes. In other embodiments, one or more others of edges 1, 2, 3 may comprise such an opening. For example, long edges 1 or 3 may comprise the opening into which the mailing materials are slid into the interior space 14.

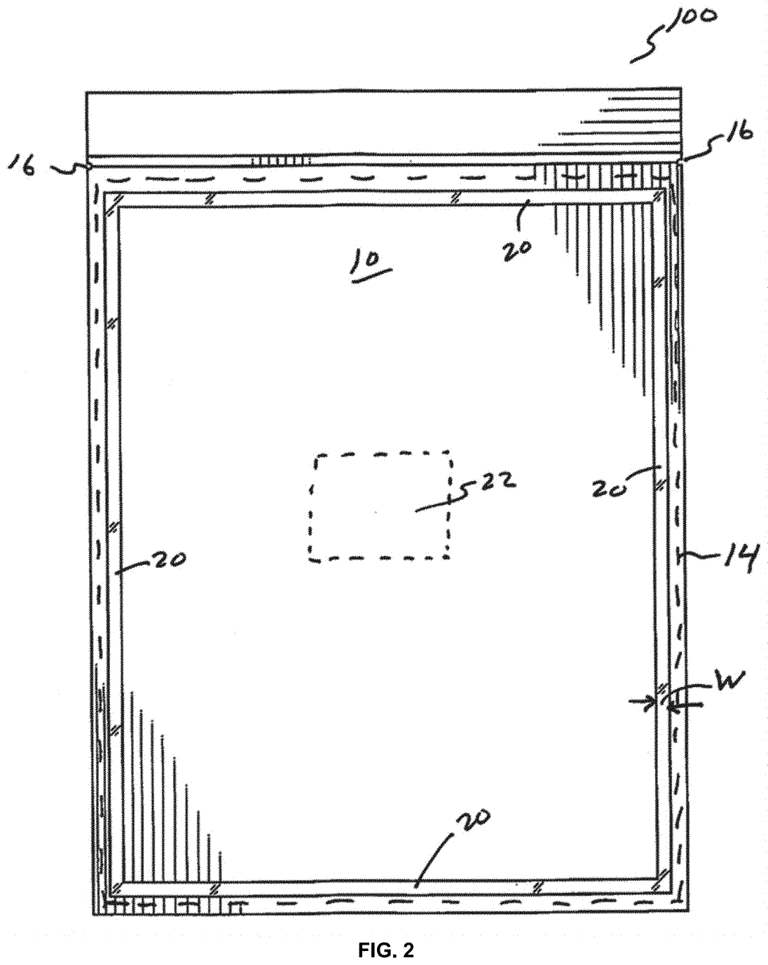

After the materials to be mailed are located within the interior space 14, the opening will be sealed by closing a flap or the equivalent over the opening and sealing with an adhesive strip or the equivalent to close the enveloping mailing container 100. The closure mechanism of enveloping mailing container 100 is exemplary and, as the skilled artisan will recognize, may comprise equivalent mechanisms, all of which are known in the art and, therefore, not described further herein. Sealed container 100 may be opened by tear notch 16 which may be disposed on the upper portion of sides 1 and 3 as shown in FIG. 2. Tear notch(es) 16 comprise an area that is cut or cut out from the upper portions of sides 1 and 3. A most preferred shape of tear notches 16 comprises a V-shape or an “arrowhead shape”, wherein the tip, or apex, of the first and second arrowhead shaped tear notches 16 defined or disposed on upper portions of sides 1 and 3, respectively, face or point toward each other. There may be further a linear region of weakened, or thinned, material disposed between tear notches 16 to help facilitate opening the sealed closure.

In some embodiments, the enveloping mailing container 100 may include one or more features enabling the enveloping mailing container 100 to be re-used as an enveloping mailing container. For example, the enveloping mailing container 100 may include an adhesive region comprising a strip of double-backed tape, which in some examples may be re-usable tape that enables the container 100 to be sealed and re-opened multiple times. This feature may be included in the container 100 in addition to or instead of the tear notch(es) 16 and the linear region of weakened or thinned material. In such examples, the strip of tape may be adhered to a flap that may be folded over the opening and engaged with a corresponding surface of the container 100 to seal the container 100, as described above. The strip of tape includes a stronger adhesive comprising a middle “anchor” layer and a weaker adhesive. The side of the strip of tape having the stronger adhesive is in contact with the extended/exposed lip area of the container 100 while the side of the strip of tape having the weaker adhesive is covered with a peel-away covering strip. A user may remove the peel-away strip and seal the container 100 closed. If the recipient intends to open the container 100 using the tear notch(es) 16, then in such examples the container 100 may not be re-usable as an enveloping mailing container. In such cases, the user may use the container 100 as a file folder or have it recycled after opening. Alternatively, if the recipient intends to re-send the container 100, he or she may “lift and peel” open the extended lip or sealable flap.

In any such examples, other features may contribute to the re-usability of the container 100 as an enveloping mailing container, such as new address labels configured for replacement or placement over a previously-used label or the like.

Certain embodiments of the container 100 comprise at least one transparent section allowing visual communication of the interior space 14, wherein the at least one transparent section 20 may be disposed or located on the front side 10. An exemplary interior space 14 is illustrated in phantom in FIG. 2 with dashed lines. Moreover, at least one transparent section 20′ may be disposed or located on the back side 12 of the container 100. Transparent section(s) 20 and/or 20′ may comprise a single transparent section 20, 20′ or may comprise a plurality or more than one transparent section 20, 20′. The transparent section(s) 20, 20′ may be continuous or may be broken up into a plurality of transparent sections and spaced across the front side 10 and/or back side 12 of the container 100. Transparent section(s) 20 and/or 20′ may comprise a material that is sufficiently strong, flexible and transparent to allow visual access to the interior space 14 while withstanding the forces of shipping. An exemplary material may comprise polystyrene, though other materials will present themselves to the skilled artisan.

The primary purpose of the transparent section(s) 20, 20′ is to provide visual access into the interior space to inspect or interrogate the interior space 14 for dangerous or otherwise unauthorized substances such as powders. Thus, the remaining portions of front and back sides 10, 12, i.e., that not defined by the transparent section(s) 20, 20′, are substantially opaque and preferably opaque.

Such inspection may be done manually or by aid of machines adapted to identify such substances. Various means for automated inspection or interrogation of the interior space 14 using machines that are known in the art and may include, without limitation, taking images of the interior space 14 via the transparent section(s) 20 and/or 20′ wherein the images are photographic and/or transmit energy within the visible wavelength spectrum or may be within other regions of the wavelength spectrum such as infrared. Thus, energy may be transmitted to, and in some cases through, the transparent section(s) 20 and/or 20′ at at least one wavelength and at least one frequency. These images may be compared with a reference database for evidence of possible contamination by the dangerous substance(s) or evaluated by other means known to the skilled artisan.

The automated inspection or interrogation may further search along at least a portion of the transparent section(s) 20 and/or 20′ for evidence of an opaqueness or transmissibility of light or other energy that is inconsistent with the transmissibility of a non-contaminated transparent section(s) 20 and/or 20′. Stated differently, interrogating energy from an interrogating machine may be substantially aligned with or focused on or move along at least a portion of the transparent section 20 and/or 20′ to discover potentially dangerous regions where something such as a powder may be affixed to the interior surface of the transparent section(s) 20 and/or 20′. When such contamination evidence is discovered, the container 100 may then be flagged for further inspection.

Thus, it will now be apparent that in certain embodiments, it will be advantageous for the at least one transparent section 20 and the at least one transparent section 20′ to be at least partially substantially aligned to facilitate the inspection and/or interrogation of the interior space 14, whether done manually or automatedly. In some cases, a scanner may be used to inspect or interrogate the interior space.

The location of the at least one transparent section 20 is preferably spaced away from the usual location of a mailing address section 22 on the front side 10 of the enveloping mailing container 100 as shown in FIG. 2 and is preferably positioned to preserve confidentiality of the mailed materials sealed within the interior space 14 while allowing visual access into the interior space 14.

A preferred configuration for the at least one transparent section(s) 20 and/or 20′ thus comprises locating the transparent section(s) 20 and/or 20′ on the front side 10 and/or back side 12, respectively, to provide visual access along at least a portion of a perimeter of the interior space 14. This allows visual access without compromising the integrity and privacy of the mailed materials. One embodiment may thus comprise a continuous transparent section 20 and/or 20′ as shown in the Figures around a perimeter of the interior space 14 and spaced away from the mailing address section 22. This embodiment may comprise a width W. In certain configurations, width W may be greater or less than 3 mm. In a preferred configuration, width W may be approximately 5 mm to facilitate visual inspection. However, it is understood that automated interrogation or inspection means may require greater or smaller widths W.

Other configurations for transparent section(s) 20 and/or 20′ will now become available to the skilled artisan, each of which is within the scope of the present invention. Thus, without limitation, the transparent section(s) 20 and/or 20′ may: comprise regular or irregular shapes; may be continuous or discontinuous; may be a single section or may comprise a plurality of sections; may be disposed only on the front side 10, only on the back side 12, or may be disposed on both the front and back sides 10, 12; and all, or some, of transparent section(s) 20 may, or may not be, aligned with transparent section(s) 20′.

In the case of a geometric shape, whether regular or irregular, the width W of the transparent section(s) 20 and/or 20′ may, as discussed above, be sized to accommodate visual and/or automated inspection or interrogation of interior space 14.

The types of enveloping mailing containers 100 that are amenable to the various embodiments of the present invention include, but are not limited to: containers manufactured with a variety of materials, e.g., and without limitation: flexible plastics such as polyethylene or a blend thereof such as polyethylene in combination with other substances; laminations that are re-useable and recyclable, such as PE/PE #4 on the Emobious Scale and OPP/CPP #5; a blend comprising polyethylene terephthalate (PET) and linear low density polyethylene (LLDPE); paper; cardboard; etc.

It is preferred that the front and/or back sides 10,12 be coated at least partially with a matte coating that reduces and/or eliminates the glossiness or glossy quality of the front and/or back sides 10,12 in the opaque region thereof. This construction may assist in the automated inspection and/or interrogation of the interior space 14 through the transition section(s) 20 and/or 20′.

The enveloping mailing containers 100 of the present invention may be used in combination with envelopes of any size or shape or material, as well as boxes and mailing tubes, including but not limited to shipping containers sold by the U.S. Postal Service, FedEx, DHS, UPS, and the like. In the case of envelopes, the front and back sides 10, 12 may be sealed directly together or may be separated by gusset(s) as is known in the art to provide additional volume to the interior space 14 when needed.

In the unique case of mailing tubes, typically formed of cardboard in a tubular shape, one or more transparent sections may be defined on one or both ends of the tube to facilitate inspection of the interior space within the tube.

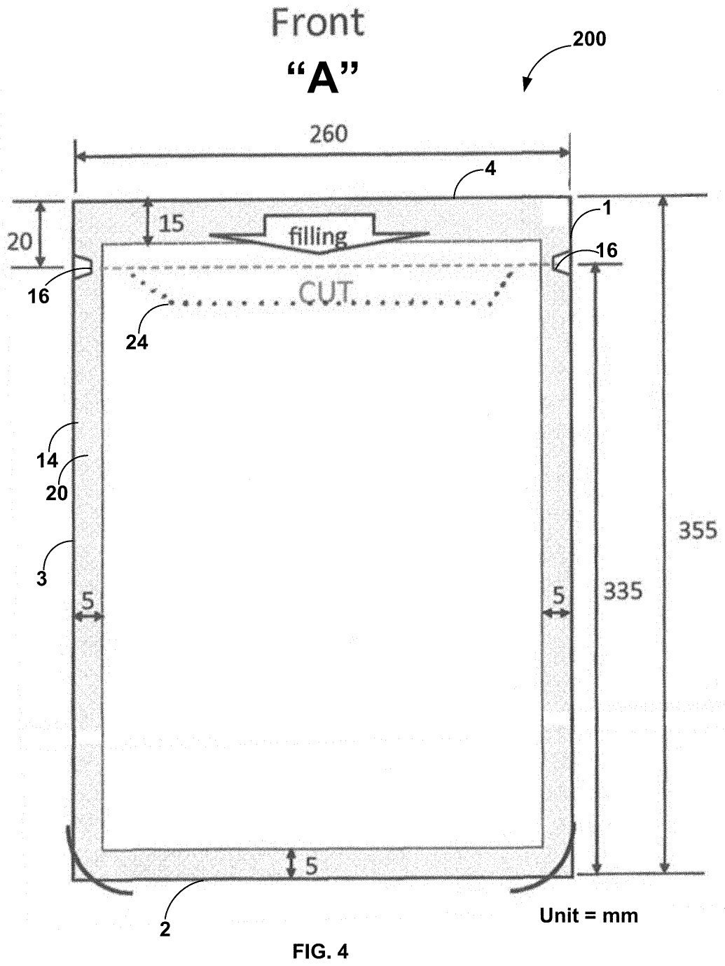

FIGS. 4-6 illustrate embodiments of mailing containers of the present invention. The mailing containers of the present invention illustrated in FIGS. 4-6 may include one or more features of mailing container 100 described above with respect to FIGS. 1-3, with like reference numerals used to denote substantially similar features. For example, the mailing containers illustrated in FIGS. 4-6 may include edges 1,2,3, and 4, an interior space 14, tear notch(es) 16, and/or transparent section(s) 20 substantially as described above with respect to FIGS. 1-3.

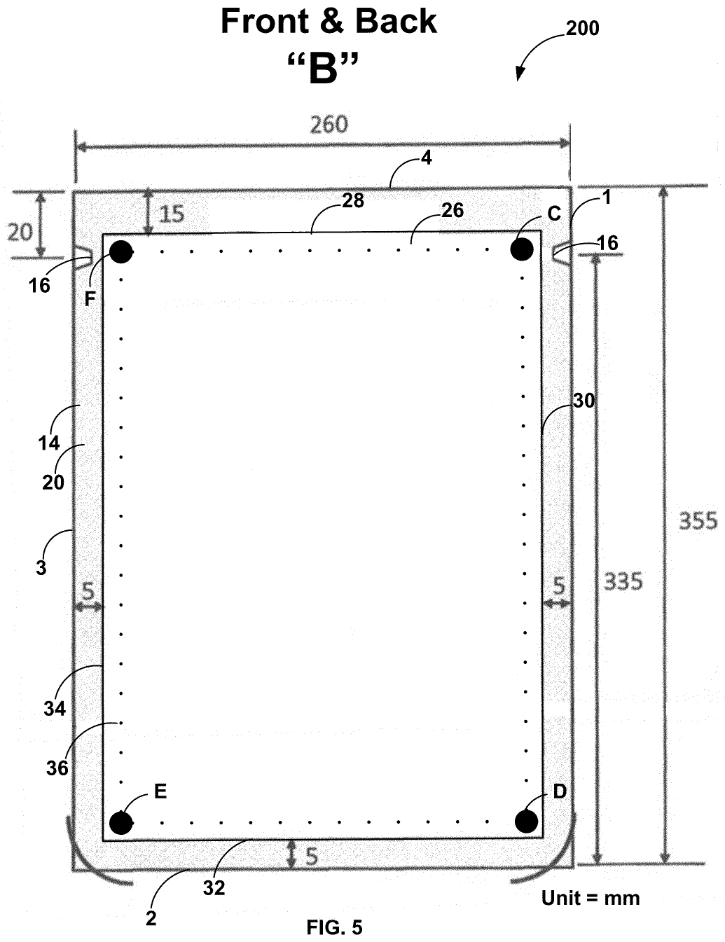

FIG. 4 provides a front view of one embodiment of a mailing container 200. Exemplary dimensions of features of mailing container 200 are illustrated in millimeters (mm). One or more of the exemplary dimensions illustrated in FIG. 4 may be modified to provide a mailing container having any desired dimensions. The mailing container 200 includes features substantially as described above with respect to mailing container 100. However, as noted on the drawing, the lip seal may be extended. When opening, the tear line will follow the perforation line 24, leaving a lower lip (see dashed line) allowing easy access to the interior of the container for use as, e.g., a file folder. It should be noted that although the line 24 is illustrated as being formed by perforation of the material of the mailing container 200 in FIGS. 4 and 5, the line 24 alternatively may be formed by scoring or otherwise thinning or weakening the material of the mailing container 200 to provide a tear line that follows a desired path. Thus any references herein to perforation of the mailing container 200 to provide a tear line should be understood as equally referring to a line formed by scoring during manufacturing of the mailing container 200.

Although the edge 4 of the mailing container 200 is illustrated as comprising the opening into which the mailing materials are slid into the interior space, one or more others of edges 1, 2, 3 may comprise such an opening. For example, long edges 1 or 3 may comprise the opening into which the mailing materials are slid into the interior space 14. In such examples, the long edges 1 or 3 may form the opening of the file folder after the mailing container 200 has been opened along a corresponding perforation line extending along the long edge 1 or 3 in a manner similar to the perforation line 24 shown extending along the edge 4. In any such examples, the perforation line may be extended along three of the edges 1, 2, 3, and 4 such that the mailing container 200 may be opened along three edges, such as along edges 2, 3, and 4. In such examples, the edge 1 may form a hinged side along which the mailing container may be opened when used as a file folder.

In some embodiments, the mailing container 200 may include one or more additional features configured to enhance the use of the mailing container 200 as a file folder after it has been opened along the perforation line 24. For example, the mailing container 200 may include one or more re-closure features configured to enable a user to re-close the mailing container 200, such as string-and-button closure(s), a winged metal clasp, an integrated, removable sticker, or others. Additionally, or alternatively, the mailing container 200 may include one or more reinforced portions along one or more of corresponding edges 1, 2, 3, and 4, which may provide durability to the mailing container during use as a file folder.

FIG. 5 provides a cross-sectional view of the front and/or back sides of the mailing container 200 illustrated in FIG. 4, where the cross-section is taken along a line substantially parallel to the long edges 1 and 3. However, it should be understood that the features described with respect to FIGS. 4 and 5 may be used in any combination in other embodiments of the present invention. As illustrated in FIG. 5, the mailing container may include bubble pack liner(s) 26 positioned within the interior space 14, which are configured to protect contents of the mailing container 200 from damage due to impact and/or bending. For example, a first sheet of bubble pack material may be positioned in engagement with an interior surface of the front side 10 and/or a second sheet of bubble pack material may be positioned in engagement with an interior surface of the back side 12. The bubble pack material may have any suitable composition and configuration of components sufficient to protect contents of the mailing container 200 from damage due to impact and/or bending.

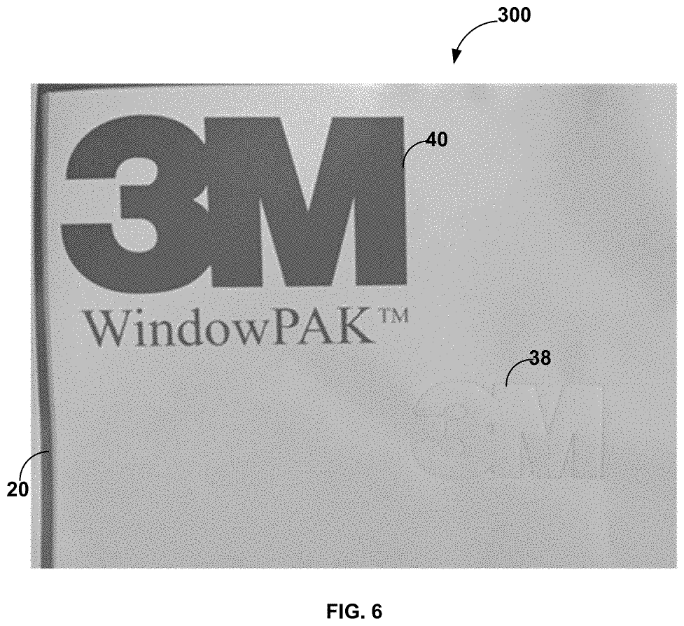

For the sake of clarity, FIG. 5 may be understood to illustrate either an interior of the front side 10 or the back side 12, with a sheet of bubble pack material 26 (i.e., “the bubble pack 26”) positioned in engagement therewith. The bubble pack 26 defines edges 28, 30, 32, and 34, which may be aligned substantially in parallel with corresponding ones of edges 1, 2, 3, and 4 of the mailing container 200. The bubble pack 26 is heat sealed near the corners of the mailing container 200 at points C, D, E, and F, with at least portions of the space along the edges 28, 30, 32, and 34 left unsealed along line 36, which extends between each of points C, D, E, and F, to the mailing container 200. In this manner, the bubble pack 26 may be held in place while still allowing any foreign and/or loose material within the container to move within the vision path at the transparent section(s) 20, such as by flowing outward from a more-central region of the interior 14 to the transparent section(s) 20. Finally, FIG. 6 provides a front view of an exemplary mailing container 300 of the present invention having a laser-produced branding design 38 provided thereon. In some examples, the mailing container 300 may include one or more features of the mailing containers 100 and/or 200 of FIGS. 1-5 in any suitable combination, such as the transparent section(s) 20 illustrated in FIG. 6. The mailing container 300 further includes a branding design 38 positioned on an exterior surface thereof. In some examples, the branding design 38 may be substantially the same color as the background material of the mailing container 300 on which it is produced so that it appears as a faint outline, as shown in FIG. 6. The branding design 38 may be achieved using any suitable laser techniques. As will be apparent now, the laser designs may comprise company logos, a family name and address and/or any other desired patterns.

Optionally, the mailing container 300 may include a printed design or logo 40 on a major surface of the mailing container 300. Although printed design or logo 40 is illustrated as being provided on the same major surface of the mailing container 300 as the branding design 38, the printed design or logo 40 additionally or alternatively may be provided on another exterior or interior surface of the mailing container 300. Similarly, the branding design 38 additionally or alternatively may be provided on any desired surface(s) of the mailing container 300. The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. An enveloping mailing container with four edges including a top edge and having an opaque front side and an opaque back side sealed together to form three edges and having a sealable opening at the fourth edge, an interior space defined between the front and back sides, and a mailing address section on the front side and spaced away from the edges, comprising:
at least one transparent section defined on the front and/or back side;
an extended lip seal;
a perforation tear line that extends downwardly away from the top edge for at least a portion of the perforation tear line; and
wherein the enveloping mailing container comprises 100% recycled material that is adapted to receive laser energy configured to provide a pre-designed pattern on the enveloping mailing container.

2. The enveloping mailing container of claim 1, further comprising a first sheet of bubble pack material with four edges positioned within the interior space and sealingly engaged with an interior surface defined by the front side of the enveloping mailing container such that less than entire length of each of the four edges of the sheet of bubble pack material sealingly engages the interior surface defined by the front side.

3. The enveloping mailing container of claim 2, wherein the first sheet of bubble pack material is positioned in sealing engagement with the interior surface defined by the front side by at least one of an adhesive and a heat-seal.

4. The enveloping mailing container of claim 2, further comprising a second sheet of bubble pack material with four edges positioned within the interior space and sealingly engaged with an interior surface defined by the back side of the enveloping mailing container such that less than entire length of each of the four edges of the sheet of bubble pack material sealingly engages the interior surface defined by the back side.

5. The enveloping mailing container of claim 4, wherein the second sheet of bubble pack material is positioned in sealing engagement with the interior surface defined by the back side by at least one of an adhesive and a heat-seal.

6. The enveloping mailing container of claim 1, further comprising a closure mechanism configured for re-closing the enveloping mailing container after the enveloping mailing container has been opened along the perforation tear line.

7. The enveloping mailing container of claim 1, wherein at least one of the front and back sides comprises a reinforced area along at least one of the four edges.

8. The enveloping mailing container of claim 1, wherein the perforation tear line further extends along two edges of the enveloping mailing container adjacent the top edge such that the enveloping mailing container may be opened along three of the four edges after being torn along the perforation tear line.

9. The enveloping mailing container of claim 1, further comprising at least one gusset disposed between the front side and the back side.

10. The enveloping mailing container of claim 1, further comprising opposing tear notches, wherein the tear notches are in the form of arrowheads with an apex, wherein the apex of a first arrowhead tear notch is pointed toward the apex of a second arrowhead shaped tear notch.

11. The enveloping mailing container of claim 1, wherein at least one transparent section defined on the front side is substantially aligned at least one transparent section defined on the back side.

12. The enveloping mailing container of claim 1, wherein the front side comprises a mailing address section spaced away from the at least one front transparent section.

13. The enveloping mailing container of claim 1, wherein at least one of the opaque front side and the opaque back side comprise a matte coating thereon.

14. The enveloping mailing container of claim 1, wherein the extended lip seal and the perforation tear line that extends downwardly away from the top edge for at least a portion of the perforation tear line configure the enveloping mailing container for use as a file folder after the enveloping mailing container has been opened along the perforation tear line.

15. The enveloping mailing container of claim 1, wherein the at least one transparent section is in visual communication with at least a portion of a perimeter of the interior space.

16. The enveloping container of claim 15, wherein the at least one transparent section comprises one continuous transparent section.

17. The enveloping mailing container of claim 1, wherein the at least one transparent section of the front side comprises a minimum width of greater than or equal to 3 mm.

18. A method for assessing a closed and sealed enveloping mailing container for potentially dangerous substances or objects disposed within the enveloping mailing container comprising:
receiving a closed and sealed enveloping mailing container according to the enveloping mailing container of claim 1;
inspecting the interior space of the received enveloping mailing container through one or more of the at least one front transparent section for potentially dangerous substances or objects; and
determining if the interior space of the closed and sealed enveloping mailing container contains a potentially dangerous substance or object.

19. The method of claim 9, wherein inspecting comprises scanning by a scanner.

20. The method of claim 9, wherein inspecting comprises transmitting energy of at least one selected wavelength and at least one frequency through the at least one transparent sections.
